(19) United States
(12) Patent Application Publication
(10) Pub. No.: US 2026/0208232 A1
(43) Pub. Date: Jul. 23, 2026

(54) AQUEOUS CLEANING AND ADHESIVE STRIPPING SYSTEM FOR MONOCRYSTALLINE SILICON WAFERS AND ADHESIVE STRIPPING PROCESS

(71) Applicant: TCL ZHONGHUAN RENEWABLE ENERGY TECHNOLOGY CO., LTD., Tianjin (CN)

(72) Inventors: Zhiwei LI, Tianjin (CN); Fei YOU, Tianjin (CN); Min ZHOU, Tianjin (CN); Minlu CHEN, Tianjin (CN); Jiajian DING, Tianjin (CN); Binbin TANG, Tianjin (CN); Xinyu ZOU, Tianjin (CN)

(73) Assignee: TCL ZHONGHUAN RENEWABLE ENERGY TECHNOLOGY CO., LTD., Tianjin (CN)

(21) Appl. No.: 19/517,445

(22) Filed: Mar. 6, 2026

Related U.S. Application Data
(63) Continuation of application No. PCT/CN2024/100274, filed on Jun. 20, 2024.

(30) Foreign Application Priority Data
Sep. 8, 2023 (CN) 202311155612.3

(51) Int. Cl. B08B 1/20; B08B 1/12; B08B 1/34; B08B 1/36; B08B 3/10

(52) U.S. Cl. CPC B08B 1/20; B08B 1/12; B08B 1/34; B08B 1/36; B08B 3/10

(57) ABSTRACT

An aqueous cleaning and adhesive stripping system for monocrystalline silicon wafers and its adhesive stripping process are provided. The system includes a basic driving mechanism configured for driving. The basic driving mechanism includes a stable base plate, a cleaning table fixedly connected to a top of the stable base plate. By arranging two cleaning installation mechanisms inside the basic driving mechanism, and with the cooperation of an electric telescopic rod and a gear cylinder, the two cleaning installation mechanisms can operate alternately, one capable of cleaning the silicon wafers and the other facilitating replacement by workers.

### CROSS REFERENCE TO RELATED APPLICATIONS

This application is a continuation of International Application No. PCT/CN2024/100274, filed on Jun. 20, 2024, which claims priority to Chinese Patent Application No. 202311155612.3, entitled “AQUEOUS CLEANING AND ADHESIVE STRIPPING SYSTEM FOR MONOCRYSTALLINE SILICON WAFERS AND ADHESIVE STRIPPING PROCESS”, filed on Sep. 8, 2023, the entire contents of which are incorporated herein by reference.

### TECHNICAL FIELD

The embodiments of the present disclosure relate to, but are not limited to, the technical field of adhesive stripping technologies for monocrystalline silicon wafers, and specifically, to an aqueous cleaning and adhesive stripping system for monocrystalline silicon wafers and an adhesive stripping process.

### BACKGROUND

Monocrystalline silicon is a relatively active non-metallic element and is an important component of crystal materials, standing at the forefront of new material development. In the production process of monocrystalline silicon wafers, strict cleaning is required. However, existing silicon wafer washing devices have poor cleaning effects, and cleaned wafer surfaces often exhibit incomplete adhesive stripping, which reduces the yield of monocrystalline silicon wafers and is unfavorable for their production. Improvements for this issue have been described in existing patent documents.

For example, patent publication No. CN217797609U discloses an aqueous cleaning and adhesive stripping device for monocrystalline silicon wafers, which includes an outer protective adhesive stripping cabinet, an adhesive stripping tank disposed inside the outer protective adhesive stripping cabinet, a lifting fixed platform disposed inside the adhesive stripping tank, a hydraulic base disposed in the lifting fixed platform, a hydraulic lifting rod disposed at the output end of the hydraulic base, a control platform disposed at the other end of the hydraulic lifting rod, and a drive motor disposed inside the control platform, an output end of the drive motor being fixedly connected to a threaded screw. A moving block is externally threaded to the threaded screw. Through the drive motor disposed inside, it can drive the threaded screw fixedly connected to its output end to rotate.

Although the above device is capable of clamping and fixing the silicon wafers and effectively removing the adhesive from the wafer surfaces by raising the water temperature, its practical application does not meet the requirements of mass production.

Generally, monocrystalline silicon wafers are produced in large batches with large quantities, while this device can only perform water washing and adhesive stripping on a single silicon wafer at a time, and each cleaning requires a certain amount of time. Therefore, its cleaning efficiency is not high and cannot meet production needs. If multiple such devices are set up simultaneously, equipment costs and labor costs increase.

Therefore, there is a need to design an aqueous cleaning and adhesive stripping system for monocrystalline silicon wafers to meet the needs of large-scale monocrystalline silicon wafer production and to resolve such defects.

### SUMMARY

The following is an overview of the subject matter described in detail herein. This overview is not intended to limit the scope of the claims.

The embodiments of the present disclosure provide an aqueous cleaning and adhesive stripping system for monocrystalline silicon wafers and its adhesive stripping process, which solve the problems of low efficiency and unsuitability for common production use in existing adhesive stripping equipment for monocrystalline silicon wafers.

To achieve the above objectives, the embodiments of the present disclosure are implemented through the following technical solution: An aqueous cleaning and adhesive stripping system for monocrystalline silicon wafers includes a basic driving mechanism for driving, wherein two cleaning installation mechanisms for adhesive stripping are disposed on both sides inside the basic driving mechanism.

Preferably, the basic driving mechanism includes a stable base plate, a cleaning table fixedly connected to a top of the stable base plate, a support linkage wall fixedly connected to a rear side of the cleaning table, slide groove plates fixedly connected to both sides of the support linkage wall, and cleaning pools disposed on both sides of a top of the cleaning table and cooperating with the cleaning installation mechanisms, wherein the two cleaning installation mechanisms are respectively disposed inside the cleaning pools.

Preferably, each of the cleaning installation mechanisms includes a slider base slidably installed inside a corresponding one of the slide groove plates, a load-bearing connection plate fixedly connected to the slider base, a sliding ring fixedly connected to a front end of the load-bearing connection plate away from the slider base, a sliding cylinder disposed inside the sliding ring, a rotating shaft rotatably connected inside the sliding cylinder, a polygonal sleeve rod fixedly connected to a lower part of the rotating shaft, and a polygonal rotating column slidably installed on the polygonal sleeve rod, wherein a plurality of rotation limiting grooves are circumferentially disposed on an outer surface of the polygonal rotating column, and an internal toothed annular frame is rotatably connected to a bottom of the rotating shaft via a bearing member.

Preferably, blocking plates are fixedly connected to the rotating shaft and cooperates with the internal toothed annular frame, a number of the blocking plates is the same as a number of the rotation limiting grooves; a plurality of fixed insertion frames are fixedly connected to the polygonal rotating column and located between every adjacent two of the rotation limiting grooves; a multi-face lifting plate is fixedly connected to the rotating shaft and located between the internal toothed annular frame and the polygonal sleeve rod; a first spring is fixedly connected between the multi-face lifting plate and the polygonal rotating column; and bearing bottom insertion plates are fixedly connected to the multi-face lifting plate and cooperates with the fixed insertion frames.

Preferably, reciprocating threaded rods are rotatably connected to a top of the rotation limiting grooves via bearing members, and bottom ends of the reciprocating threaded rods extend through the blocking plates and into the internal toothed annular frame; a limiting threaded sleeve is threadedly connected to a surface of a corresponding one of the reciprocating threaded rods located inside the rotation limiting grooves; both sides of the limiting threaded sleeve are fixedly connected to scraping brush plates configured to cooperate with the fixed insertion frames; through-circular ports are circumferentially formed in a bottom of the internal toothed annular frame and cooperates with the reciprocating threaded rods; internal limiting gear rings meshing with the internal toothed annular frame are slidably installed on a side of the reciprocating threaded rods located inside the internal toothed annular frame; and a bottom of the internal toothed annular frame is fixedly connected to a polygonal positioning block.

Preferably, a toothed plate is fixedly connected to, via a bracket, a side of the load-bearing connection plate in one of the two cleaning installation mechanisms facing to the load-bearing connection plate in another one of the two cleaning installation mechanisms; a limit pushing groove is formed in the load-bearing connection plate and penetrates the load-bearing connection plate from top to bottom; a second arc-shaped block is slidably installed inside the limit pushing groove; a second spring is fixedly connected between the second arc-shaped block and a front part of an inner cavity of the limit pushing groove; an arc-shaped friction ring cooperating with the rotating shaft is fixedly connected to a bottom of the second arc-shaped block via a bracket; and a polygonal tapered insertion rod is fixedly connected to a top end of the rotating shaft.

Preferably, a motor is fixedly connected to a top of the support linkage wall via a bracket; an output shaft of the motor is fixedly connected to a rotating rod via a coupling; a bottom end of the rotating rod passes through the support linkage wall and extends into an inner cavity of the support linkage wall; second pulley wheels are fixedly connected to an upper part and a lower part of the rotating rod located inside the support linkage wall; first pulley wheels are rotatably connected to both sides of a top of the inner cavity of the support linkage wall via bearing frames; the second pulley wheels and the first pulley wheels are connected by belts for transmission; first arc-shaped blocks are fixedly connected to both sides of the top of the inner cavity of the support linkage wall via brackets, and each of the first arc-shaped blocks cooperates with the second arc-shaped block; a gear cylinder cooperating with the toothed plate is rotatably connected to a rear part of the inner cavity of the support linkage wall via a bearing member.

Preferably, circular lifting ports are formed on both sides of the top of the support linkage wall, and each of the circular lifting ports cooperates with the polygonal tapered insertion rod; a rectangular lifting port is formed on a rear side of the top of the support linkage wall and cooperates with the toothed plate; a limit moving groove is formed on a rear part of the support linkage wall; lower pushing rods are fixedly connected to both sides of the top of the inner cavity of the support linkage wall via brackets, and each of lower pushing rods cooperates with the polygonal rotating column; an electric telescopic rod is fixedly installed on the rear part of the support linkage wall, and a top end of the electric telescopic rod is fixedly connected to the toothed plate at right side via a fixed plate; a bottom of an inner cavity of each of the cleaning pools is fixedly connected to a polygonal insertion slot seat cooperating with the polygonal positioning block via an opened port.

The present disclosure also discloses a process for aqueous cleaning and adhesive stripping monocrystalline silicon wafers, specifically including the following steps:
S1. injecting a cleaning liquid into cleaning pools, then sequentially inserting monocrystalline silicon wafers into fixed insertion frames of a right-side cleaning installation mechanism, wherein a bottom of each of the monocrystalline silicon wafers engages with a corresponding one of bearing bottom insertion plates, until all the monocrystalline silicon wafers are inserted;
S2. actuating an electric telescopic rod, wherein the electric telescopic rod pulls the fixed insertion frames of the right-side cleaning installation mechanism to descend under guidance of a right-side slide groove plate; driving a rotating shaft and a polygonal rotating column of the right-side cleaning installation mechanism by a load-bearing connection plate of the right-side cleaning installation mechanism to descend through an action of a sliding ring and a sliding cylinder of the right-side cleaning installation mechanism until the polygonal rotating column, the fixed insertion frames, and the bearing bottom insertion plates descend into one of the cleaning pools on a right side and the monocrystalline silicon wafers are completely immersed in the cleaning liquid; inserting a polygonal positioning block of the right-side cleaning installation mechanism into one of polygonal insertion slot seats on the right side to fix an internal toothed annular frame of the right-side cleaning installation mechanism, releasing a multi-face lifting plate of the right-side cleaning installation mechanism from downward pull of the rotating shaft to separate the bearing bottom insertion plates from the fixed insertion frames, allowing the monocrystalline silicon wafers to be connected to the fixed insertion frames, and inserting a polygonal tapered insertion rod of the right-side cleaning installation mechanism into one of first pulley wheels on the right side to complete engagement; actuating a motor to drive the rotating shaft of the right-side cleaning installation mechanism and a rotating shaft of a left-side cleaning installation mechanism to rotate via second pulley wheels, the first pulley wheels, and belts, wherein the rotating shaft drives the polygonal rotating column to rotate by a polygonal sleeve rod of the right-side cleaning installation mechanism and drives the fixed insertion frames to rotate, so that the cleaning liquid impacts the monocrystalline silicon wafers; driving a plurality of internal limiting gear rings of the right-side cleaning installation mechanism to revolve through rotation of the polygonal rotating column, wherein the plurality of internal limiting gear rings are engaged with the internal toothed annular frame, so that reciprocating threaded rods of the right-side cleaning installation mechanism are driven to rotate, and in turn limiting threaded sleeves of the right-side cleaning installation mechanism are driven to move up and down through rotation of the reciprocating threaded rods within rotation limiting grooves of the right-side cleaning installation mechanism; and cleaning both sides of the monocrystalline silicon wafers with scraping brush plates of the right-side cleaning installation mechanism;
S3. driving a gear cylinder to rotate through a toothed plate of the right-side cleaning installation mechanism when the right-side cleaning installation mechanism is descending, wherein rotation of the gear cylinder drives an left-side cleaning installation mechanism to rise and detach from the cleaning pools via a toothed plate of the left-side cleaning installation mechanism, after the left-side cleaning installation mechanism rises, a polygonal tapered insertion rod of the left-side cleaning installation mechanism disengages from one of the first pulley wheels on a left side and rises to a top through one of circular lifting ports on the left side, thereby positioning a rotating shaft of the left-side cleaning installation mechanism inside one of the first pulley wheels on the left side without contact so that rotation of the one of the first pulley wheels on the left side does not drive the rotating shaft of the left-side cleaning installation mechanism to rotate; pushing a polygonal rotating column of left-side cleaning installation mechanism to rotate upward via a first spring of left-side cleaning installation mechanism when the rotating shaft of the left-side cleaning installation mechanism rises, wherein the polygonal rotating column of left-side cleaning installation mechanism, after rising, contacts one of lower pushing rods on the left side, then during upward pulling of the rotating shaft of the left-side cleaning installation mechanism, an internal toothed annular frame and a multi-face lifting plate of the left-side cleaning installation mechanism rise, bearing bottom insertion plates of the left-side cleaning installation mechanism rise again to contact fixed insertion frames of the left-side cleaning installation mechanism to facilitate lifting of the wafers for easy removal; and subjecting reciprocating threaded rods of the left-side cleaning installation mechanism to extending below the internal toothed annular frame of the left-side cleaning installation mechanism through through-circular ports of the left-side cleaning installation mechanism, wherein when a load-bearing connection plate of the left-side cleaning installation mechanism rises to the top, a first arc-shaped block of the left-side cleaning installation mechanism contacts a second arc-shaped block of the left-side cleaning installation mechanism to push an arc-shaped friction ring of the left-side cleaning installation mechanism forward to contact the rotating shaft of the left-side cleaning installation mechanism, thereby fixing the rotating shaft of the left-side cleaning installation mechanism and preventing rotation to facilitate replacement of the wafers.

Preferably, in steps S2 and S3, the right-side cleaning installation mechanism and the left-side cleaning installation mechanism are operated in an alternating manner.

After reading and understanding the accompanying diagrams and detailed descriptions, the other aspects can be understood.

### BENEFICIAL EFFECTS

The embodiments of the present disclosure provide an aqueous cleaning and adhesive stripping system for monocrystalline silicon wafers and its adhesive stripping process. The beneficial effects are as follows:
(1) According to the aqueous cleaning and adhesive stripping system for monocrystalline silicon wafers of the present disclosure, by arranging two cleaning installation mechanisms inside the basic driving mechanism, and with the cooperation of the electric telescopic rod and the gear cylinder, the two cleaning installation mechanisms can operate alternately. One can clean the silicon wafers while the other facilitates replacement by workers. Moreover, the rising and descending of a single cleaning installation mechanism can complete different functions. During descending and rotation, the scraping brush plates and the impact force of water can efficiently remove the adhesive on the surface. During rising, the bearing bottom insertion plates can lift the silicon wafers, and the arc-shaped friction ring limits the rotating shaft, facilitating replacement by workers. This effectively improves the cleaning efficiency of the silicon wafers, is convenient to use, and meets current needs.
(2) By rotatably connecting the internal toothed annular frame to the bottom of the rotating shaft, and connecting the reciprocating threaded rod inside the rotation limiting groove, with the limiting threaded sleeve and the internal limiting gear ring connected to the surface of the reciprocating threaded rod, and used in conjunction with the polygonal insertion slot seat and the polygonal positioning block, when the rotating shaft rotates, the polygonal insertion slot seat first fixes the internal toothed annular frame. Then, the multiple internal limiting gear rings, under the meshing with the internal toothed annular frame, drive the reciprocating threaded rods to rotate, thereby causing the scraping brush plates to remove the adhesive from the adjacent silicon wafer surfaces, improving adhesive stripping efficiency and quality.
(3) By installing the first arc-shaped blocks cooperating with the second arc-shaped blocks at the top of the inner cavity of the support linkage wall, these structures, through the rising of the load-bearing connection plate, cause the first arc-shaped blocks to abut against the second arc-shaped blocks, using the second arc-shaped blocks to push the arc-shaped friction ring to contact the rotating shaft and increase friction, thereby stopping and fixing the rotating shaft, making it more stable for workers during wafer removal and installation.
(4) By installing the multiple bearing bottom insertion plates cooperating with the fixed insertion frames on the lower surface of the rotating shaft via the multi-face lifting plate, these structures allow the silicon wafers to be completely immersed inside the fixed insertion frames during descent, facilitating cleaning. During ascent, the bearing bottom insertion plates push the silicon wafers out of the fixed insertion frames, facilitating removal.

### BRIEF DESCRIPTION OF THE DRAWINGS

FIG. 1 is a schematic structural diagram according to embodiments of the present disclosure.

FIG. 2 is a sectional view of a cleaning table structure according to embodiments of the present disclosure.

FIG. 3 is a schematic diagram of second pulley wheels, belts, and first arc-shaped block structures according to embodiments of the present disclosure.

FIG. 4 is a schematic diagram of a rectangular lifting port, limit moving groove, lower pushing rod, and electric telescopic rod structure according to embodiments of the present disclosure.

FIG. 5 is a schematic diagram of a cleaning installation mechanism structure according to embodiments of the present disclosure.

FIG. 6 is a schematic diagram of a rotating rod, polygonal sleeve rod, and polygonal tapered insertion rod structure according to embodiments of the present disclosure.

FIG. 7 is a partial enlarged view of area A in FIG. 6.

FIG. 8 is a partial enlarged view of area B in FIG. 6.

FIG. 9 is a schematic diagram of an internal toothed annular frame, through-circular port, and polygonal positioning block structure according to embodiments of the present disclosure.

FIG. 10 is a schematic diagram of a fixed insertion frame, multi-face lifting plate, and bearing bottom insertion plate structure according to embodiments of the present disclosure.

FIG. 11 is a schematic diagram of a reciprocating threaded rod, limiting threaded sleeve, and scraping brush plate structure according to embodiments of the present disclosure.

FIG. 12 is a partial enlarged view of area C in FIG. 11.

List of reference signs: 1. Basic driving mechanism; 2. Cleaning installation mechanism; 101. Stable base plate; 102. Cleaning table; 103. Support linkage wall; 104. Slide groove plate; 105. Cleaning pool; 106. Motor; 107. Rotating rod; 108. First pulley wheel; 109. Second pulley wheel; 110. Belt; 111. First arc-shaped block; 112. Gear cylinder; 113. Circular lifting port; 114. Rectangular lifting port; 115. Limit moving groove; 116. Lower pushing rod; 117. Electric telescopic rod; 118. Polygonal insertion slot seat; 201. Slider base; 202. Load-bearing connection plate; 203. Sliding ring; 204. Sliding cylinder; 205. Rotating shaft; 206. Polygonal sleeve rod; 207. Polygonal rotating column; 208. Rotation limiting groove; 209. Internal toothed annular frame; 210. Blocking plate; 211. Fixed insertion frame; 212. Multi-face lifting plate; 213. Bearing bottom insertion plate; 214. Reciprocating threaded rod; 215. Limiting threaded sleeve; 216. Scraping brush plate; 217. Through-circular port; 218. Polygonal positioning block; 219. Internal limiting gear ring; 220. First spring; 221. Toothed plate; 222. Limit pushing groove; 223. Second arc-shaped block; 224. Second spring; 225. Arc-shaped friction ring; 226. Polygonal tapered insertion rod.

### DETAILED DESCRIPTION

The technical solutions in the embodiments of the present disclosure will be described clearly and fully below with reference to the accompanying drawings in the embodiments of the present disclosure.

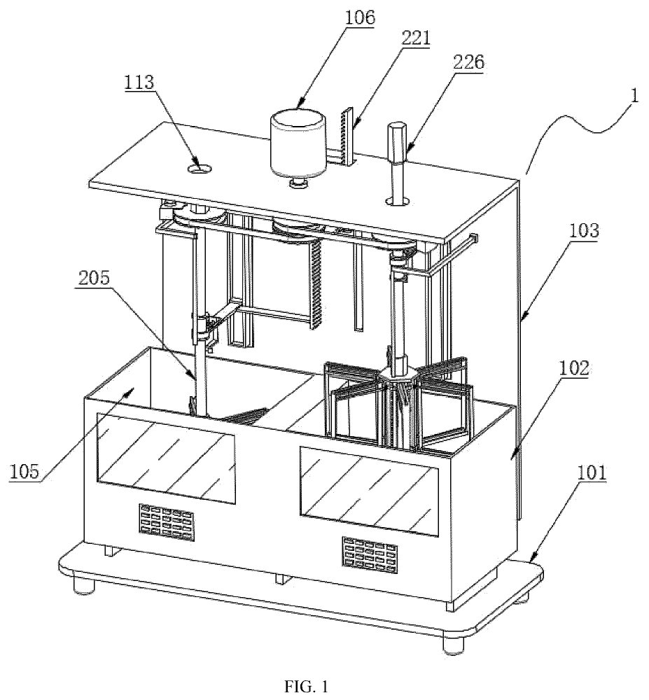

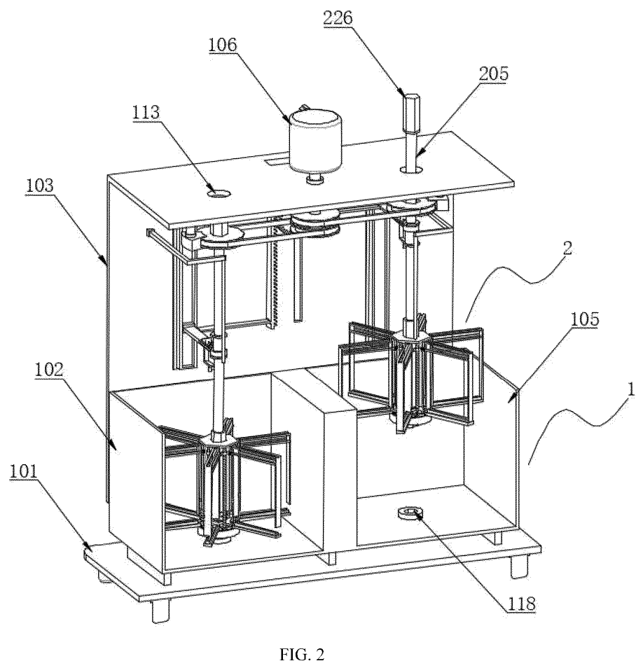

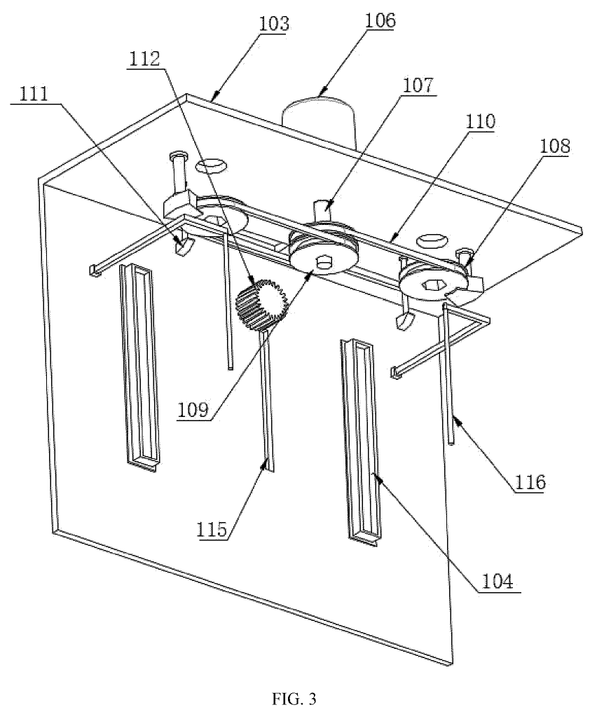

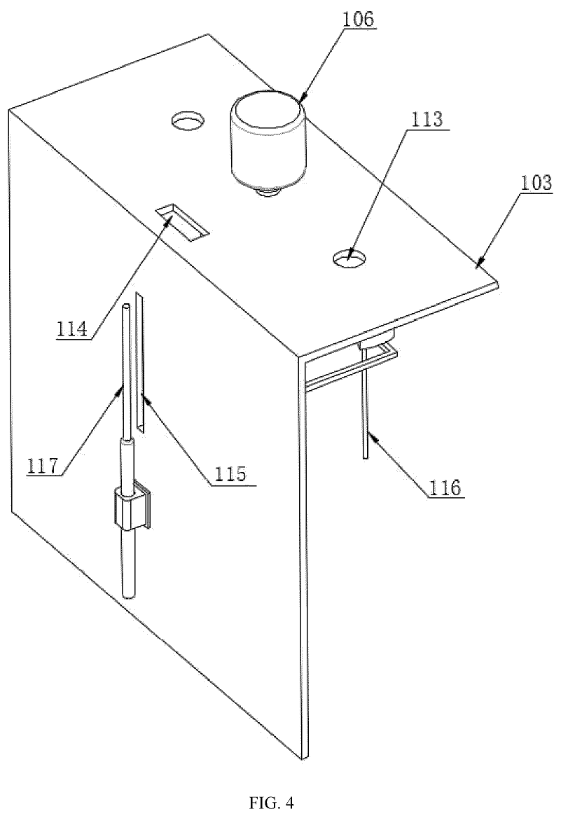

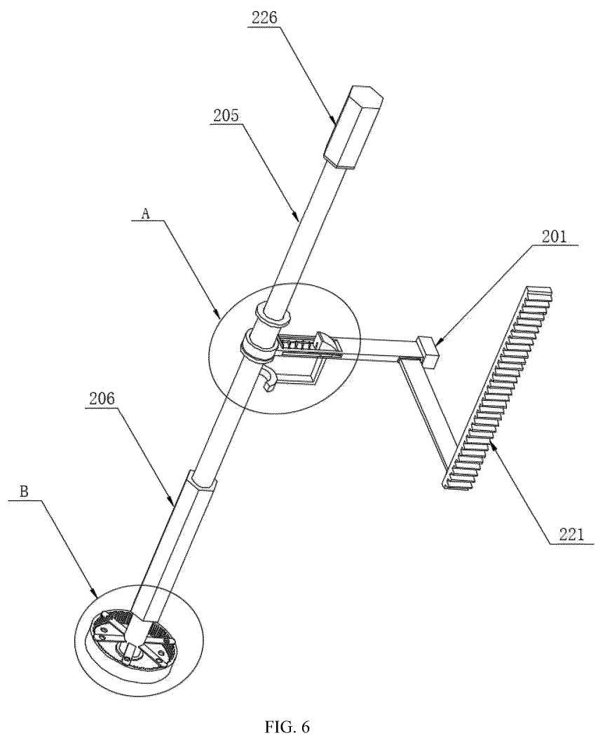

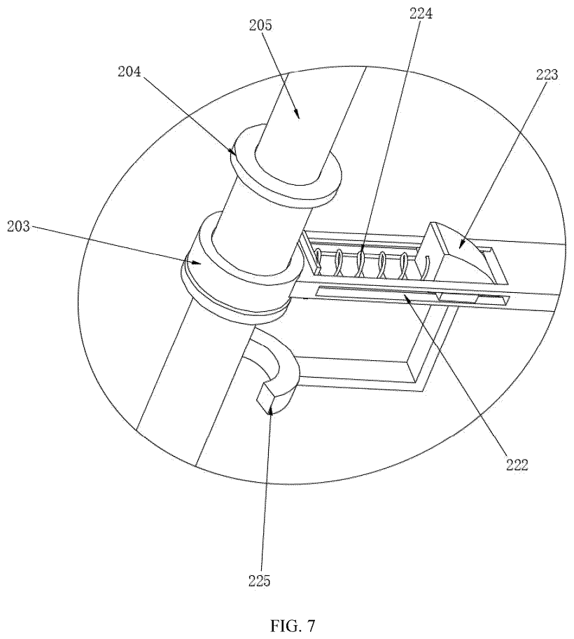

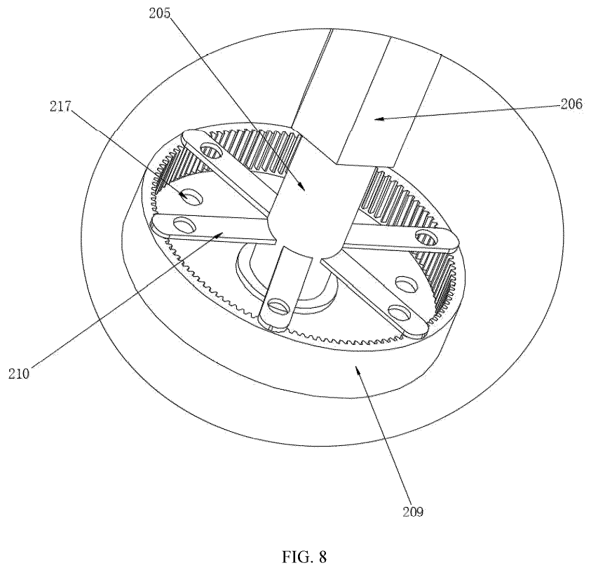

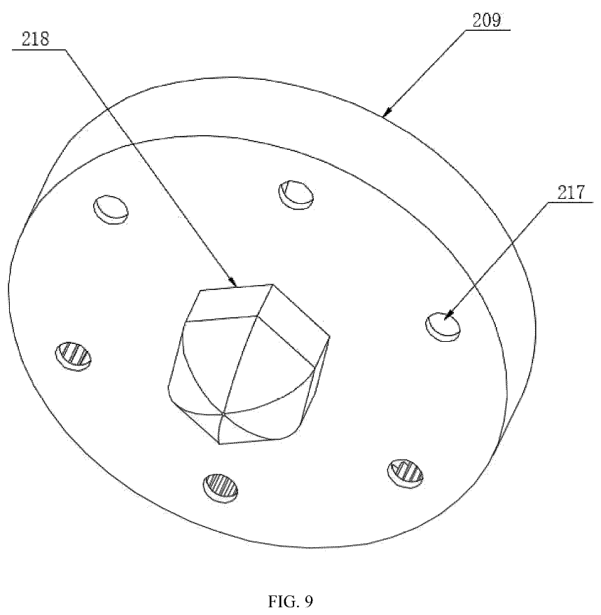

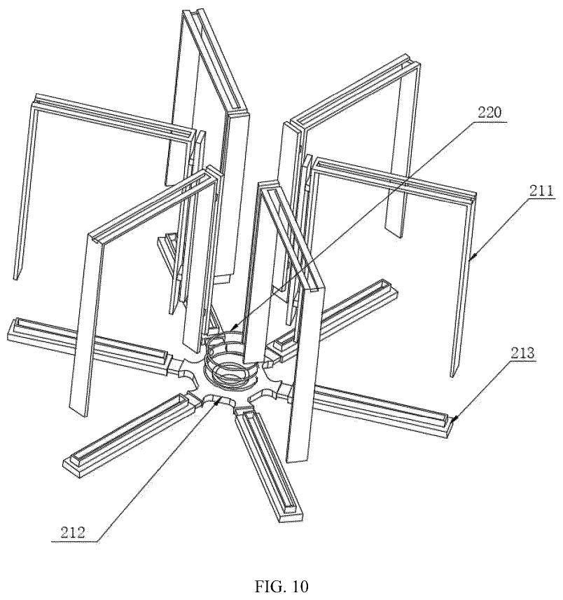

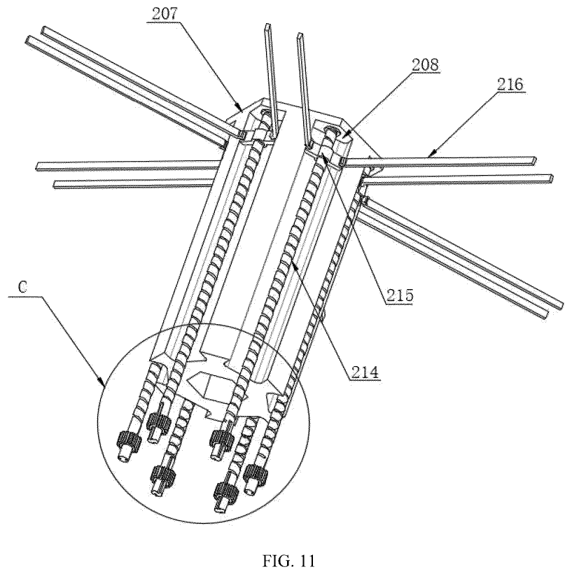

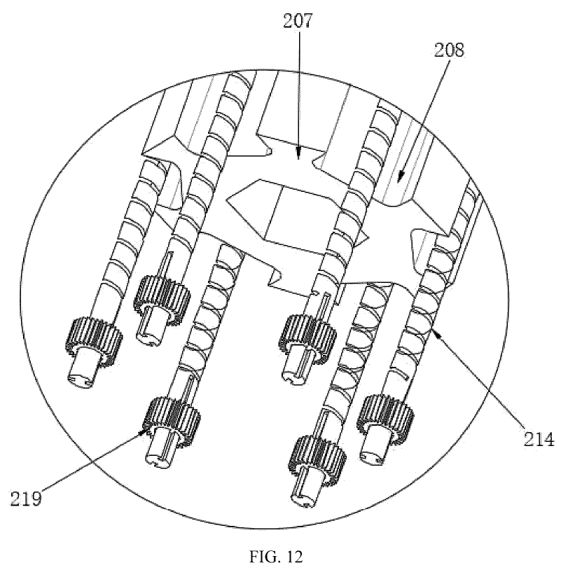

Referring to FIGS. 1 to 12, embodiments of the present disclosure provide an aqueous cleaning and adhesive stripping system for monocrystalline silicon wafers, which comprises a basic driving mechanism 1 for driving. Two cleaning installation mechanisms 2 for adhesive stripping are disposed on both sides inside the basic driving mechanism 1.

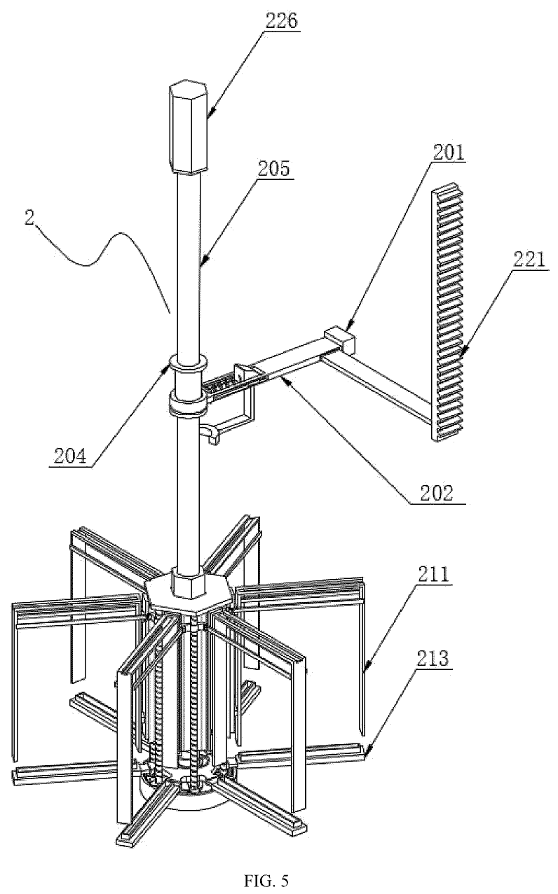

Referring to FIGS. 5, 6, 7, 8, 9, 10, 11, and 12, the overall structure of the cleaning installation mechanism 2 is shown. The basic driving mechanism 1 includes a stable base plate 101. A cleaning table 102 is fixedly connected to a top of the stable base plate 101. A support linkage wall 103 is fixedly connected to a rear side of the cleaning table 102. Slide groove plates 104 are fixedly connected to both sides of the support linkage wall 103. Cleaning pools 105 cooperating with the cleaning installation mechanisms 2 are formed on both sides of a top of the cleaning table 102. The cleaning pools 105 have draining functions. The two cleaning installation mechanisms 2 are respectively disposed inside the cleaning pools 105. The cleaning installation mechanism 2 includes a slider base 201 that is configured to slidably install inside the slide groove plate 104. A load-bearing connection plate 202 is fixedly connected to a surface of the slider base 201. A sliding ring 203 is fixedly connected to a front end of the load-bearing connection plate 202. A sliding cylinder 204 is disposed inside the sliding ring 203. The sliding ring 203 and the sliding cylinder 204 are not connected to each other. A rotating shaft 205 is rotatably connected inside the sliding cylinder 204. A polygonal sleeve rod 206 is fixedly connected to a lower part of the rotating shaft 205. A polygonal rotating column 207 is slidably installed on the polygonal sleeve rod 206. A plurality of rotation limiting grooves 208 are circumferentially disposed on an outer surface of the polygonal rotating column 207. An internal toothed annular frame 209 is rotatably connected to a bottom of the rotating shaft 205 via a bearing member. Blocking plates 210 cooperating with the internal toothed annular frame 209 are fixedly connected to the rotating shaft 205. A number of the blocking plates 210 is the same as a number of the rotation limiting grooves 208. One or more fixed insertion frames 211 are fixedly connected to the polygonal rotating column 207, located between every two adjacent rotation limiting grooves 208. The fixed insertion frames 211 are made of stainless steel, and the frames are slender so that they can only sleeve on an edge of the silicon wafer without blocking adhesive stripping. A plurality of the fixed insertion frames 211 are provided. A multi-face lifting plate 212 is fixedly connected to the rotating shaft 205, located between the internal toothed annular frame 209 and the polygonal sleeve rod 206. A first spring 220 is fixedly connected between the multi-face lifting plate 212 and the polygonal rotating column 207. One or more bearing bottom insertion plates 213 cooperating with the fixed insertion frames 211 are fixedly connected to the multi-face lifting plate 212. An inner side of the bearing bottom insertion plates 213 is made of rubber material and is configured to butt against and clamp the silicon wafer after insertion. A top of an inner cavity of the rotation limiting groove 208 is rotatably connected to a reciprocating threaded rod 214 via a bearing member. Slotted openings capable of limiting sliding are formed in lower parts of both sides of the reciprocating threaded rod 214. A bottom end of the reciprocating threaded rod 214 passes through the blocking plate 210 and extends into the internal toothed annular frame 209. A limiting threaded sleeve 215 is threadedly connected to the reciprocating threaded rod 214, located inside the rotation limiting groove 208. Scraping brush plates 216 cooperating with the fixed insertion frames 211 are fixedly connected to both sides of the limiting threaded sleeve 215. A side of the scraping brush plates 216 facing the silicon wafer is provided with brushes. A bottom of the internal toothed annular frame 209 is circumferentially provided with through-circular ports 217 cooperating with the reciprocating threaded rod 214. An internal limiting gear ring 219 meshing with the internal toothed annular frame 209 is slidably installed on the reciprocating threaded rod 214, located inside the internal toothed annular frame 209. An inner side of the internal limiting gear ring 219 is provided with a limiting sliding protrusion cooperating with the reciprocating threaded rod 214. A polygonal positioning block 218 is fixedly connected to a bottom of the internal toothed annular frame 209. Toothed plates 221 are fixedly connected to the sides of the two load-bearing connection plates 202 facing each other via brackets. A limit pushing groove 222 penetrating from top to bottom is disposed in the load-bearing connection plate 202. A second arc-shaped block 223 is slidably installed inside the limit pushing groove 222. A second spring 224 is fixedly connected between the second arc-shaped block 223 and a front part of an inner cavity of the limit pushing groove 222. An arc-shaped friction ring 225 cooperating with the rotating shaft 205 is fixedly connected to a bottom of the second arc-shaped block 223 via a bracket. An inner side of the arc-shaped friction ring 225 is rough, and after contacting the rotating shaft 205, friction increases to fix it. A polygonal tapered insertion rod 226 is fixedly connected to a top end of the rotating shaft 205. Edge portions at a bottom end of the polygonal tapered insertion rod 226 are arc-shaped to facilitate connection.

Referring to FIGS. 1, 2, 3, and 4, the overall structure of the basic driving mechanism 1 is shown. A motor 106 is fixedly connected to a top of the support linkage wall 103 via a bracket. The motor 106 is a servo motor. An output shaft of the motor 106 is fixedly connected to a rotation rod 107 via a coupling. A bottom end of the rotation rod 107 passes through the support linkage wall 103 and extends into an inner cavity of the support linkage wall 103. Second pulley wheels 109 are fixedly connected to an upper part and a lower part of the rotation rod 107, located inside the support linkage wall 103. First pulley wheels 108 are rotatably connected to both sides of a top of the inner cavity of the support linkage wall 103 via bearing frames. The second pulley wheels 109 and the first pulley wheels 108 are connected by belts 110 for transmission. First arc-shaped blocks 111 cooperating with the second arc-shaped blocks 223 are fixedly connected to both sides of the top of the inner cavity of the support linkage wall 103 via brackets. A gear cylinder 112 cooperating with the toothed plates 221 is rotatably connected to a rear part of the inner cavity of the support linkage wall 103 via a bearing member. Circular lifting ports 113 cooperating with the polygonal tapered insertion rods 226 are formed on both sides of the top of the support linkage wall 103. A rectangular lifting port 114 cooperating with the toothed plates 221 is formed on a rear side of the top of the support linkage wall 103. A limit moving groove 115 is formed on a rear part of the support linkage wall 103. Lower pushing rods 116 cooperating with the polygonal rotating columns 207 are fixedly connected to both sides of the top of the inner cavity of the support linkage wall 103 via brackets. An electric telescopic rod 117 is fixedly installed on a rear part of the support linkage wall 103, and a top end of the electric telescopic rod 117 is fixedly connected to the right-side toothed plate 221 via a fixed plate. A bottom of an inner cavity of the cleaning pool 105 is fixedly connected to a polygonal insertion slot seat 118 cooperating with the polygonal positioning block 218 via an opened port.

Embodiments of the present disclosure also provide an aqueous cleaning and adhesive stripping process for monocrystalline silicon wafers, specifically including steps S1 to S3.
S1. During use, a cleaning liquid is first injected into the cleaning pools 105. Then, the monocrystalline silicon wafers are sequentially inserted into the fixed insertion frames 211 on the right side. The bottom of each wafer is engaged with the inner side of a corresponding bearing bottom insertion plate 213. After all wafers are installed, the process proceeds to step S2.
S2. After the wafers are installed in the right-side cleaning installation mechanism 2, the electric telescopic rod 117 is actuated. The right-side fixed insertion frames 211 are pulled downward by the electric telescopic rod 117, guided by the slide groove plates 104. The load-bearing connection plate 202, through the sliding ring 203 and the sliding cylinder 204, drives the rotating shaft 205 and the polygonal rotating column 207 to descend. The polygonal rotating column 207, the fixed insertion frames 211, and the bearing bottom insertion plates 213 also descend together into the cleaning pool 105, completely immersing the wafers in the liquid. The polygonal positioning block 218 is inserted into the polygonal insertion slot seat 118, thereby fixing the internal toothed annular frame 209. Simultaneously, the multi-face lifting plate 212, no longer being pulled by the rotating shaft 205, descends, causing the bearing bottom insertion plates 213 to separate from the fixed insertion frames 211. The wafers are thus fully inserted into the fixed insertion frames 211. Concurrently, the right-side polygonal tapered insertion rod 226 is inserted into the first pulley wheel 108, completing the connection. Subsequently, the motor 106 is actuated. Through the action of the second pulley wheels 109, the first pulley wheels 108, and the belts 110, both rotating shafts 205 are driven to rotate. The rotating shaft 205 drives the entire polygonal rotating column 207 to rotate via the polygonal sleeve rod 206. The rotation of the fixed insertion frames 211 causes an aqueous cleaning liquid to impact the wafers. While the polygonal rotating column 207 rotates, it drives the multiple internal limiting gear rings 219 to revolve. Due to the meshing between the internal limiting gear rings 219 and the internal toothed annular frame 209, the reciprocating threaded rods 214 are driven to rotate. The rotation of the reciprocating threaded rods 214, constrained by the rotation limiting grooves 208, drives the limiting threaded sleeves 215 to move up and down. The scraping brush plates 216 clean both sides of the wafers. The process then proceeds to step S3.
S3. While the right-side cleaning installation mechanism 2 is descending, the toothed plate 221 drives the gear cylinder 112 to rotate. The rotation of the gear cylinder 112, via the left-side toothed plate 221, causes the entire left-side cleaning installation mechanism 2 to rise and detach from the cleaning pool 105. After the left-side cleaning installation mechanism 2 rises, the polygonal tapered insertion rod 226 is disengaged from the first pulley wheel 108 and rises to the top through the circular lifting port 113. This positions the rotating shaft 205 inside the first pulley wheel 108 without contact, so the rotation of the first pulley wheel 108 does not drive the left-side rotating shaft 205 to rotate. As the rotating shaft 205 rises, the polygonal rotating column 207 is first pushed upward by the first spring 220. After rising, the polygonal rotating column 207 first contacts the lower pushing rods 116. Then, during the upward pulling of the rotating shaft 205, the internal toothed annular frame 209 and the multi-face lifting plate 212 rises. The bearing bottom insertion plates 213 rise again to contact the fixed insertion frames 211, facilitating the subsequent lifting of the wafers for easy removal. The reciprocating threaded rods 214 extend below the internal toothed annular frame 209 through the through-circular ports 217. When the load-bearing connection plate 202 rises to the top, the first arc-shaped block 111 contacts the second arc-shaped block 223, pushing the arc-shaped friction ring 225 forward to contact the rotating shaft 205, thereby fixing the rotating shaft 205 and preventing rotation, which facilitates the replacement of the wafers. In steps S2 and S3, the two cleaning installation mechanisms 2 operate in an alternating manner.

The above embodiments are only used to illustrate the present disclosure and do not limit the technical solutions described in the present disclosure. Although the present disclosure has been described in detail with reference to the above embodiments, the present disclosure is not limited to the specific implementations described above. Therefore, any modifications or equivalent replacements made to the present disclosure; and all technical solutions and improvements that do not depart from the spirit and scope of the invention shall be covered within the scope of the claims of the present disclosure.

The above descriptions are only preferred specific embodiments of the present disclosure, but the protection scope of the present disclosure is not limited thereto. Any person skilled in the art, within the technical scope disclosed in the present disclosure, according to the technical solutions and inventive concepts of the present disclosure, can make equivalent replacements or changes, which shall be covered within the protection scope of the present disclosure.

What is claimed is:

1. An aqueous cleaning and adhesive stripping system for monocrystalline silicon wafers, comprising a basic driving mechanism configured for driving, wherein two cleaning installation mechanisms configured for adhesive stripping are disposed on both sides inside the basic driving mechanism.

2. The system according to claim 1, wherein the basic driving mechanism comprises a stable base plate, a cleaning table fixedly connected to a top of the stable base plate, a support linkage wall fixedly connected to a rear side of the cleaning table, slide groove plates fixedly connected to both sides of the support linkage wall, and cleaning pools disposed on both sides of a top of the cleaning table and cooperating with the cleaning installation mechanisms, wherein the two cleaning installation mechanisms are respectively disposed inside the cleaning pools.

3. The system according to claim 2, wherein each of the cleaning installation mechanisms comprises a slider base slidably installed inside a corresponding one of the slide groove plates, a load-bearing connection plate fixedly connected to the slider base, a sliding ring fixedly connected to a front end of the load-bearing connection plate away from the slider base, a sliding cylinder disposed inside the sliding ring, a rotating shaft rotatably connected inside the sliding cylinder, a polygonal sleeve rod fixedly connected to a lower part of the rotating shaft, and a polygonal rotating column slidably installed on the polygonal sleeve rod, wherein a plurality of rotation limiting grooves are circumferentially disposed on an outer surface of the polygonal rotating column, and an internal toothed annular frame is rotatably connected to a bottom of the rotating shaft via a bearing member.

4. The system according to claim 3, wherein blocking plates are fixedly connected to the rotating shaft and cooperates with the internal toothed annular frame, a number of the blocking plates is the same as a number of the rotation limiting grooves; a plurality of fixed insertion frames are fixedly connected to the polygonal rotating column and located between every two adjacent ones of the rotation limiting grooves; a multi-face lifting plate is fixedly connected to the rotating shaft and located between the internal toothed annular frame and the polygonal sleeve rod; a first spring is fixedly connected between the multi-face lifting plate and the polygonal rotating column; and bearing bottom insertion plates are fixedly connected to the multi-face lifting plate and cooperate with the fixed insertion frames.

5. The system according to claim 4, wherein reciprocating threaded rods are rotatably connected to a top of the rotation limiting grooves via bearing members, and bottom ends of the reciprocating threaded rods extend through the blocking plates and into the internal toothed annular frame; a limiting threaded sleeve is threadedly connected to a surface of a corresponding one of the reciprocating threaded rods located inside the rotation limiting grooves; both sides of the limiting threaded sleeve are fixedly connected to scraping brush plates configured to cooperate with the fixed insertion frames; through-circular ports are circumferentially formed in a bottom of the internal toothed annular frame and cooperates with the reciprocating threaded rods; internal limiting gear rings meshing with the internal toothed annular frame are slidably installed on a side of the reciprocating threaded rods located inside the internal toothed annular frame; and a bottom of the internal toothed annular frame is fixedly connected to a polygonal positioning block.

6. The system according to claim 3, wherein a toothed plate is fixedly connected to, via a bracket, a side of the load-bearing connection plate in one of the two cleaning installation mechanisms facing to the load-bearing connection plate in another one of the two cleaning installation mechanisms; a limit pushing groove is formed in the load-bearing connection plate and penetrates the load-bearing connection plate from top to bottom; a second arc-shaped block is slidably installed inside the limit pushing groove; a second spring is fixedly connected between the second arc-shaped block and a front part of an inner cavity of the limit pushing groove; an arc-shaped friction ring cooperating with the rotating shaft is fixedly connected to a bottom of the second arc-shaped block via a bracket; and a polygonal tapered insertion rod is fixedly connected to a top end of the rotating shaft.

7. The system according to claim 6, wherein a motor is fixedly connected to a top of the support linkage wall via a bracket; an output shaft of the motor is fixedly connected to a rotating rod via a coupling; a bottom end of the rotating rod passes through the support linkage wall and extends into an inner cavity of the support linkage wall; second pulley wheels are fixedly connected to an upper part and a lower part of the rotating rod located inside the support linkage wall; first pulley wheels are rotatably connected to both sides of a top of the inner cavity of the support linkage wall via bearing frames; the second pulley wheels and the first pulley wheels are connected by belts for transmission; first arc-shaped blocks are fixedly connected to both sides of the top of the inner cavity of the support linkage wall via brackets, and each of the first arc-shaped blocks cooperates with the second arc-shaped block; a gear cylinder cooperating with the toothed plate is rotatably connected to a rear part of the inner cavity of the support linkage wall via a bearing member.

8. The system according to claim 7, wherein circular lifting ports are formed on both sides of the top of the support linkage wall, and each of the circular lifting ports cooperates with the polygonal tapered insertion rod; a rectangular lifting port is formed on a rear side of the top of the support linkage wall and cooperates with the toothed plate; a limit moving groove is formed on a rear part of the support linkage wall; lower pushing rods are fixedly connected to both sides of the top of the inner cavity of the support linkage wall via brackets, and each of lower pushing rods cooperates with the polygonal rotating column; an electric telescopic rod is fixedly installed on the rear part of the support linkage wall, and a top end of the electric telescopic rod is fixedly connected to the toothed plate at right side via a fixed plate; a bottom of an inner cavity of each of the cleaning pools is fixedly connected to a polygonal insertion slot seat cooperating with the polygonal positioning block via an opened port.

9. A process for aqueous cleaning and adhesive stripping monocrystalline silicon wafers, comprising:
S1. injecting a cleaning liquid into cleaning pools, then sequentially inserting monocrystalline silicon wafers into fixed insertion frames of a right-side cleaning installation mechanism, wherein a bottom of each of the monocrystalline silicon wafers engages with a corresponding one of bearing bottom insertion plates, until all the monocrystalline silicon wafers are inserted;
S2. actuating an electric telescopic rod, wherein the electric telescopic rod pulls the fixed insertion frames of the right-side cleaning installation mechanism to descend under guidance of a right-side slide groove plate;
driving a rotating shaft and a polygonal rotating column of the right-side cleaning installation mechanism by a load-bearing connection plate of the right-side cleaning installation mechanism to descend through an action of a sliding ring and a sliding cylinder of the right-side cleaning installation mechanism until the polygonal rotating column, the fixed insertion frames, and the bearing bottom insertion plates descend into one of the cleaning pools on a right side and the monocrystalline silicon wafers are completely immersed in the cleaning liquid;
inserting a polygonal positioning block of the right-side cleaning installation mechanism into one of polygonal insertion slot seats on the right side to fix an internal toothed annular frame of the right-side cleaning installation mechanism, releasing a multi-face lifting plate of the right-side cleaning installation mechanism from downward pull of the rotating shaft to separate the bearing bottom insertion plates from the fixed insertion frames, allowing the monocrystalline silicon wafers to be connected to the fixed insertion frames, and inserting a polygonal tapered insertion rod of the right-side cleaning installation mechanism into one of first pulley wheels on the right side to complete engagement;
actuating a motor to drive the rotating shaft of the right-side cleaning installation mechanism and a rotating shaft of a left-side cleaning installation mechanism to rotate via action of second pulley wheels, the first pulley wheels, and belts, wherein the rotating shaft drives the polygonal rotating column to rotate by a polygonal sleeve rod of the right-side cleaning installation mechanism and drives the fixed insertion frames to rotate, so that the cleaning liquid impacts the monocrystalline silicon wafers;
driving a plurality of internal limiting gear rings of the right-side cleaning installation mechanism to revolve through rotation of the polygonal rotating column, wherein the plurality of internal limiting gear rings are engaged with the internal toothed annular frame, so that reciprocating threaded rods of the right-side cleaning installation mechanism are driven to rotate, and in turn limiting threaded sleeves of the right-side cleaning installation mechanism are driven to move up and down through rotation of the reciprocating threaded rods within rotation limiting grooves of the right-side cleaning installation mechanism; and
cleaning both sides of the monocrystalline silicon wafers with scraping brush plates of the right-side cleaning installation mechanism;
S3. driving a gear cylinder to rotate through a toothed plate of the right-side cleaning installation mechanism when the right-side cleaning installation mechanism is descending, wherein rotation of the gear cylinder drives an left-side cleaning installation mechanism to rise and detach from the cleaning pools via a toothed plate of the left-side cleaning installation mechanism, after the left-side cleaning installation mechanism rises, a polygonal tapered insertion rod of the left-side cleaning installation mechanism disengages from one of the first pulley wheels on a left side and rises to a top through one of circular lifting ports on the left side, thereby positioning a rotating shaft of the left-side cleaning installation mechanism inside one of the first pulley wheels on the left side without contact so that rotation of the one of the first pulley wheels on the left side does not drive the rotating shaft of the left-side cleaning installation mechanism to rotate;
pushing a polygonal rotating column of left-side cleaning installation mechanism to rotate upward via a first spring of left-side cleaning installation mechanism when the rotating shaft of the left-side cleaning installation mechanism rises, wherein the polygonal rotating column of left-side cleaning installation mechanism, after rising, contacts one of lower pushing rods on the left side, then during upward pulling of the rotating shaft of the left-side cleaning installation mechanism, an internal toothed annular frame and a multi-face lifting plate of the left-side cleaning installation mechanism rise, bearing bottom insertion plates of the left-side cleaning installation mechanism rise again to contact fixed insertion frames of the left-side cleaning installation mechanism to facilitate lifting of the wafers for easy removal; and
subjecting reciprocating threaded rods of the left-side cleaning installation mechanism to extending below the internal toothed annular frame of the left-side cleaning installation mechanism through through-circular ports of the left-side cleaning installation mechanism, wherein when a load-bearing connection plate of the left-side cleaning installation mechanism rises to the top, a first arc-shaped block of the left-side cleaning installation mechanism contacts a second arc-shaped block of the left-side cleaning installation mechanism to push an arc-shaped friction ring of the left-side cleaning installation mechanism forward to contact the rotating shaft of the left-side cleaning installation mechanism, thereby fixing the rotating shaft of the left-side cleaning installation mechanism and preventing rotation to facilitate replacement of the wafers.

10. The process according to claim 9, wherein in steps S2 and S3, the right-side cleaning installation mechanism and the left-side cleaning installation mechanism are operated in an alternating manner.
